(19) United States
(12) Patent Application Publication
(10) Pub. No.: US 2026/0017910 A1
(43) Pub. Date: Jan. 15, 2026

(54) METHOD AND APPARATUS FOR POSITIONING INTERACTION COMPONENT OF OPEN-VOCABULARY 3D TARGET, DEVICE, AND STORAGE MEDIUM

(71) Applicant: Beijing Zitiao Network Technology Co., Ltd., Beijing (CN)

(72) Inventors: Zhishan ZHOU, Beijing (CN); Yunke CAI, Beijing (CN); Chunjie WANG, Beijing (CN); Xiaosheng YAN, Beijing (CN); Min DU, Beijing (CN); Xiao LIU, Beijing (CN)

(21) Appl. No.: 19/265,604

(22) Filed: Jul. 10, 2025

(30) Foreign Application Priority Data
Jul. 10, 2024 (CN) 202410925471.7

(51) Int. Cl. G06T 19/20; G06V 10/26; G06V 10/30; G06V 10/52; G06V 10/77; G06V 10/82; G06V 10/96

(52) U.S. Cl. CPC G06T 19/20; G06V 10/26; G06V 10/30; G06V 10/52; G06V 10/7715; G06V 10/82; G06V 10/96; G06T 2219/2004

(57) ABSTRACT

A method and an apparatus for positioning an interactive component of an open-vocabulary 3D target, a device, and a storage medium. The method includes: acquiring text description information of a target task and an image sequence of a real scene; and inputting the text description information and the image sequence into an interactive component positioning model to obtain a positioning result of an interactive component of a target object to be operated by the target task, wherein the interactive component positioning model includes a large language model (LLM), an open-vocabulary 2D detection and segmentation model, a filtering module, and a 3D projection module.

### CROSS-REFERENCE TO RELATED APPLICATION

This application claims the priority of Chinese Patent Application No. 202410925471.7 filed on Jul. 10, 2024, and the disclosure of the above-mentioned Chinese Patent Application is hereby incorporated in its entirety by reference as a part of this application

### TECHNICAL FIELD

Embodiments of the present disclosure relate to the technical field of image processing, and in particular, to a method and an apparatus for positioning an interactive component of an open-vocabulary 3D target, a device, and a storage medium.

### BACKGROUND

Positioning on an interactive component of an open-vocabulary 3D target is an emerging technical direction. Inputs of positioning on the interactive component of the open-vocabulary 3D target includes one 3D scene and one task description (e.g., “open the door”, “turn on the ceiling light”, etc.), and an output (i.e., the target) is a specific position of a component which needs to be operated for completing a corresponding task. For example, for a task of opening the door, a position of an operative component, i.e., a door handle, needs to be output; and for a task of turning on the ceiling light, a position of an operative component, i.e., a switch, needs to be output.

Currently, open-vocabulary 3D target positioning methods are mainly focused on segmentation and detection of a complete 3D object, and it is lack of a method for positioning a more fine-grained component of a 3D object. If the open-vocabulary 3D target positioning method for a complete 3D object is directly applied to positioning on a component of the 3D object, a problem of low accuracy of a positioning result will be caused.

### SUMMARY

Embodiments of the present disclosure provide a method and an apparatus for positioning an interactive component of an open-vocabulary 3D target, a device, and a storage medium.

In a first aspect, an embodiment of the present disclosure provides a method for positioning an interactive component of an open-vocabulary 3D target. The method includes:
acquiring text description information of a target task and an image sequence of a real scene; and
inputting the text description information and the image sequence into an interactive component positioning model to obtain a positioning result of an interactive component of a target object to be operated by the target task, where the interactive component positioning model includes a large language model (LLM), an open-vocabulary 2D detection and segmentation model, a filtering module, and a 3D projection module;
the LLM is configured to analyze the text description information to obtain information of the interactive component of the target object to be operated by the target task;
the open-vocabulary 2D detection and segmentation model is configured to perform detection and segmentation on the interactive component by using the information of the interactive component and the image sequence as an input, to obtain a 2D segmentation mask of the interactive component;
the filtering module is configured to screen a candidate image sequence where the 2D segmentation mask of the interactive component is located according to the text description information and the candidate image sequence, to obtain a target image sequence; and
the 3D projection module is configured to project a 2D segmentation mask of a target image in the target image sequence onto a 3D scene according to depth information of the target image, and correct a projection result to obtain a position of the interactive component in the 3D scene.

In some exemplary embodiments, the filtering module is configured to:
take the text description information and the candidate image sequence as an input of a vision-language model,
where the vision-language model is configured to extract a text feature of the text description information and an image feature of a 2D segmentation mask of each frame of candidate image in the candidate image sequence, and calculate a similarity between the text feature and the image feature of each frame of candidate image; and
select, from a plurality of frames of candidate images according to similarities of the plurality of frames of candidate images, K frames of candidate images with highest similarities as the target image.

In some exemplary embodiments, the vision-language model is configured to:
extract, for each frame of candidate image, multi-scale features from the 2D segmentation mask of the candidate image, and aggregate the multi-scale features to obtain the image feature of the candidate image.

In some exemplary embodiments, the vision-language model aggregates the multi-scale features to obtain the image feature of the candidate image, which is realized by:
performing weighted averaging on the multi-scale features to obtain the image feature of the candidate image.

In some exemplary embodiments, the vision-language model is a contrastive language-image pre-training (CLIP) model.

In some exemplary embodiments, the target image sequence includes a plurality of frames of target images, and the 3D projection module is configured to:
merge and project 2D segmentation masks of the plurality of frames of target images onto the 3D scene according to depth information of the plurality of frames of target images, to obtain a first 3D segmentation mask of the interactive component;
perform point cloud augmentation on sparse point cloud of the first 3D segmentation mask, to obtain a complete and dense second 3D segmentation mask;
re-project the second 3D segmentation mask onto the plurality of frames of target images to obtain a first 2D segmentation mask of the interactive component in each frame of target image;
filter out, for each frame of target image, a projected point outside the 2D segmentation mask of the target image from the first 2D segmentation mask according to a position of the 2D segmentation mask of the target image, to obtain a second 2D segmentation mask of the interactive component;
project second 2D segmentation masks of the plurality of frames of target images onto the 3D scene according to depth information of the plurality of frames of target images, to obtain a third 3D segmentation mask; and
determine the position of the interactive component in the 3D scene according to the third 3D segmentation mask.

In some exemplary embodiments, the 3D projection module is configured to determine the position of the interactive component in the 3D scene according to the third 3D segmentation mask, which is realized by:
filtering out a noise point from the third 3D segmentation mask to obtain a fourth 3D segmentation mask; and
determining the position of the interactive component in the 3D scene according to the fourth 3D segmentation mask.

In some exemplary embodiments, the filtering out a noise point from the third 3D segmentation mask to obtain a fourth 3D segmentation mask comprises:
determining a connected component according to a pixel point in the third 3D segmentation mask, and filtering out an isolated noise point from the third 3D segmentation mask according to a size of the connected component, to obtain the fourth 3D segmentation mask.

In some exemplary embodiments, the LLM is configured to analyze the text description information to obtain the information of the interactive component of the target object to be operated by the target task, which is realized by:
generating a prompt of the LLM according to the text description information; and
inputting the prompt into the LLM to obtain a name of the interactive component of the target object to be operated by the target task.

In some exemplary embodiments, a grounding segment anything model (grounding-SAM) is adopted as the open-vocabulary 2D detection and segmentation model.

In a second aspect, an embodiment of the present disclosure provides an apparatus for positioning an interactive component of an open-vocabulary 3D target. The apparatus includes:
an acquisition module, configured to acquire text description information of a target task and an image sequence of a real scene; and
a positioning module, configured to input the text description information and the image sequence into an interactive component positioning model to obtain a positioning result of an interactive component of a target object to be operated by the target task, where the interactive component positioning model includes an LLM, an open-vocabulary 2D detection and segmentation model, a filtering module, and a 3D projection module;
the LLM is configured to analyze the text description information to obtain information of the interactive component of the target object to be operated by the target task;
the open-vocabulary 2D detection and segmentation model is configured to perform detection and segmentation on the interactive component by using the information of the interactive component and the image sequence as an input, to obtain a 2D segmentation mask of the interactive component;
the filtering module is configured to screen a candidate image sequence where the 2D segmentation mask of the interactive component is located according to the text description information and the candidate image sequence, to obtain a target image sequence; and
the 3D projection module is configured to project a 2D segmentation mask of a target image in the target image sequence onto a 3D scene according to depth information of the target image, and correct a projection result to obtain a position of the interactive component in the 3D scene.

In a third aspect, an embodiment of the present disclosure provides an electronic device. The electronic device includes: a processor and a memory. The memory is configured to store a computer program, and the processor is configured to invoke and execute the computer program stored in the memory to execute the method according to the first aspect above.

In a fourth aspect, an embodiment of the present disclosure provides a non-transitory computer-readable storage medium. The non-transitory computer-readable storage medium is configured to store a computer program which enables a computer to execute the method according to the first aspect above.

In a fifth aspect, an embodiment of the present disclosure provides a computer program product, including a computer program. When executed by a processor, the computer program causes the processor to implement the method according to the first method above.

### BRIEF DESCRIPTION OF DRAWINGS

In order to more clearly illustrate the technical solution(s) of the embodiments of the present disclosure, the accompanying drawings that need to be used in the description of the embodiments will be briefly introduced below. It is obvious that the described drawings are only related to some embodiments of the disclosure, and those ordinary skilled in the art also can obtain other drawings, without any inventive work, according to these drawings.

FIG. 1 is a flowchart of a method for positioning an interactive component of an open-vocabulary 3D target, as provided by an Embodiment I of the present disclosure;

FIG. 2 is a schematic diagram of a processing process of a positioning model for an interactive component of an open-vocabulary 3D target;

FIG. 3 is a schematic diagram of an input and an output of an LLM;

FIG. 4 is a schematic diagram of a segmentation processing of a Grounding-SAM;

FIG. 5 is a schematic diagram of a filtering processing on an image by a CLIP model;

FIG. 6 is a flowchart of a method for positioning an interactive component of an open-vocabulary 3D target, as provided by an Embodiment II of the present disclosure;

FIGS. 7a-7d are schematic diagrams of data changes in a projecting and correcting process of a 3D projection module;

FIG. 8 is a schematic structural diagram of an apparatus for positioning an interactive component of an open-vocabulary 3D target, as provided by an Embodiment III of the present disclosure; and

FIG. 9 is a schematic structural diagram of an electronic device provided by an Embodiment IV of the present disclosure.

### DETAILED DESCRIPTION

Hereinafter, the technical solution(s) of the embodiments of the present disclosure will be described in a clearly and fully understandable way in connection with the drawings related to the embodiments of the present disclosure. It is obvious that the described embodiments are just a part but not all of the embodiments of the present disclosure. Based on the embodiments of the present disclosure, those ordinary skilled in the art can obtain other embodiment(s), without any inventive work, which should be within the scope of protection of the present disclosure.

It should be noted that terms such as “first”, “second” and the like in the description, claims, and the drawings of the present disclosure are used for distinguishing similar objects, instead of describing a specific order or a sequence. It should be understood that data used in this way may be exchanged in a proper case, so that the embodiments of the present disclosure described herein can be implemented in a sequence except for those graphically shown or described herein. In addition, terms such as “include/comprise” and “has/have” as well as any their variants are intended to cover non-exclusive inclusion, and for example, a process, a method, a system, a product, or a server including a series of steps or units does not need to be limited to those steps or units listed clearly, but may include other steps or units which are not listed clearly or are inherent for the process, method, product, or device.

In order to facilitate understanding the embodiments of the present disclosure, before each embodiment of the present disclosure is described, some concepts involved in all the embodiments of the present disclosure are illustrated properly first.

“Open-vocabulary” is also referred to as open vocabulary, and is a concept relative to closed vocabulary. In a computer vision task, the open vocabulary refers to an extensible set of tags, which allows a system to self-update and learn a new tag when encountering a new object or scene, and can be adapted to the diversity of the real world better; as comparison, the closed vocabulary has a fixed set of tags.

Most of conventional tasks such as task segmentation, detection, tracking and the like are based on a closed set, which means that a model (e.g., a deep neural network model) can only identify predefined categories existing in a training set. However, an open-vocabulary based model can identify and position new categories of objects in an image, which have not been appeared in the training set. It has the important application value in the fields of robot technology, automatic driving, Mix reality (MR for short), etc.

Positioning on an interactive component of an open-vocabulary 3D target is implemented by inputting a 3D scene and text description information of a random task, and a positioning model for an interactive component of an open-vocabulary 3D target (an interactive component positioning model, for short) outputs a positioning result of an interactive component of a target object to be operated by the corresponding task, and the interactive component is also referred to as a functional component.

The method provided by embodiments of the present disclosure may be executed by a terminal device or a server. The terminal device may be an XR device, various types of robots, an intelligent driving vehicle, an unmanned aerial vehicle, a mobile phone, a tablet personal computer, a desktop computer, a portable notebook computer, etc. The XR device may be a virtual reality (VR) device, an augmented reality (AR) device, or a MR device. The server is configured to detect the 3D target, and for example, the server is a control device of an unmanned vehicle.

After the application scene of the embodiments of the present disclosure is illustrated, a method for positioning an interactive component of an open-vocabulary 3D target, as provided by the embodiments of the present disclosure, will be illustrated in detail below in connection with the drawings.

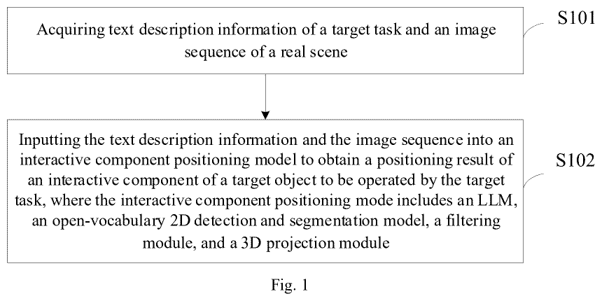

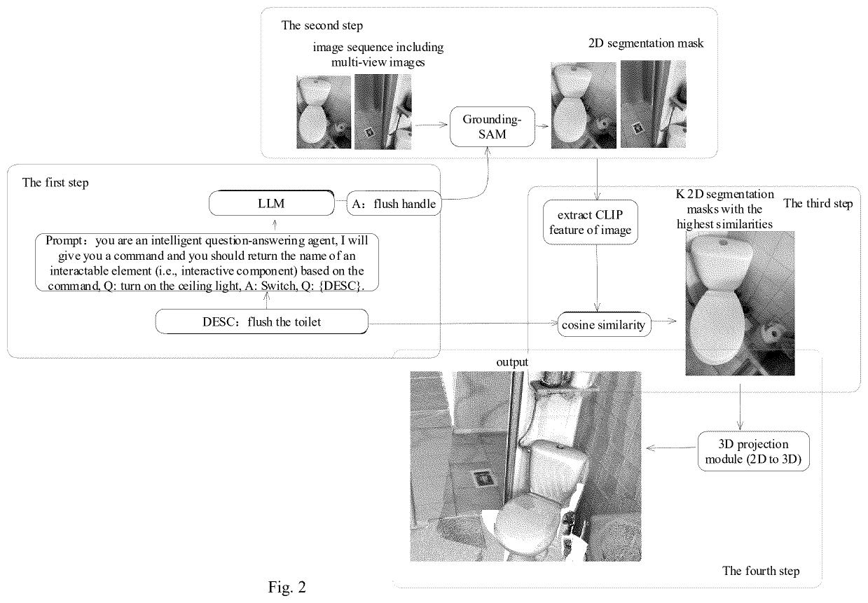

FIG. 1 is a flowchart of a method for positioning an interactive component of an open-vocabulary 3D target, as provided by an Embodiment I of the present disclosure. An execution body of this embodiment is a terminal device or a server. Illustration is carried out below by using the terminal device as an example. FIG. 2 is a schematic diagram of a processing process of a positioning model for an interactive component of an open-vocabulary 3D target. Referring to FIG. 1 and FIG. 2, the method provided by this embodiment includes the following steps:
S101: acquiring text description information of a target task and an image sequence of a real scene.

The terminal device provides an input page for tasks, a user inputs text description information of a to-be-executed target task in the input page, the text description information may include information of a target object to be operated by the target task and an action to be executed by the task, and the information of the target object to be operated by the target task may include a name of the target object.

Exemplarily, the text description information of the target task is “flush the toilet”, or the text description information of the target task is “open the window”, or the text description information of the target task is “turn on the light”.

An image sequence of a real scene includes a plurality of frames of images. The image sequence may be a video of a real scene (or referred to as a real world and a physical scene) captured by a camera of the terminal device, or may be a video of a real scene captured by cameras of other devices, other devices send the captured video of the real scene to the terminal device, and the terminal device performs positioning on the interactive component of the open-vocabulary 3D target.
S102: inputting the text description information and the image sequence into an interactive component positioning model to obtain a positioning result of an interactive component of a target object to be operated by the target task, where the interactive component positioning model includes an LLM, an open-vocabulary 2D detection and segmentation model, a filtering module, and a 3D projection module.

The LLM is configured to analyze the text description information of the target task to obtain information of the interactive component of the target object to be operated by the target task.

The open-vocabulary 2D detection and segmentation model is configured to perform detection and segmentation on the interactive component by using the information of the interactive component and the image sequence as inputs, to obtain a 2D segmentation mask of the interactive component.

The filtering module is configured to screen a candidate image sequence where the 2D segmentation mask of the interactive component is located, according to the text description information and the candidate image sequence, to obtain a target image sequence.

The 3D projection module is configured to project a 2D segmentation mask of a target image in the target image sequence onto a 3D scene according to depth information of the target image, and correct a projection result to obtain a position of the interactive component in the 3D scene.

The positioning model for an interactive component of an open-vocabulary 3D target implements detection and positioning on the interactive component of the open-vocabulary 3D target based on a pipeline (PPL for short) of a pre-training model; and each of the LLM, the open-vocabulary 2D detection and segmentation model, and the filtering module can adopt a pre-training model.

The LLM refers to a nature language processing model with a huge number of parameters, and generally understands and generates human language by training on a large-scale corpus based on deep learning technology, in particular to a Transformer architecture.

The large language model has powerful context understanding ability, and thus can understand the context of a text better and generate a response which conforms to the language environment better. The large language model further has a generative ability, not only can understand and analyze the text, but also can generate natural and fluent language, and thus can be applied to various generative tasks.

In this embodiment, the LLM can generate the information of the interactive component of the target object to be operated by the target task according to the text description information of the target task; and the information of the interactive component includes a name of the interactive component, and optionally, may also include other information of the interactive component, e.g., a position, a function, etc. of the interactive component, which is not limited in the embodiments of the present disclosure.

An input of the LLM is a prompt, which is an input of a large language model. The prompt is an input of a natural language and is configured to indicate which actions the model should adopt or what kind of output the model should generate in the process of executing the task, and thus, the prompt can also be understood as a command or an instruction. A good prompt can enable the model to understand the demands of the user more accurately so as to give out a more useful answer.

Without loss of generality, the prompt includes an instruction part, a context, input data, and an output indicator.

The instruction part is configured to describe a specific instruction or task which is specified by the user and needs to be completed by the model, and the instruction part commonly describes the task or the instruction in the form of natural language. The context is configured to describe some additional context information and configured to assist the model in learning, and for example, the context includes some specific Demonstrations of the task. The input part may be some specific questions or contents, and the input part may be different according to usage scenes. The output indicator is configured to describe a requirement on an output result of the large language model, and this requirement may be a requirement for the content and the form of the output result.

Exemplarily, the terminal device generates a prompt of the LLM according to the text description information of the target task, and inputs the prompt into the LLM to obtain the name of the interactive component of the target object to be operated by the target task.

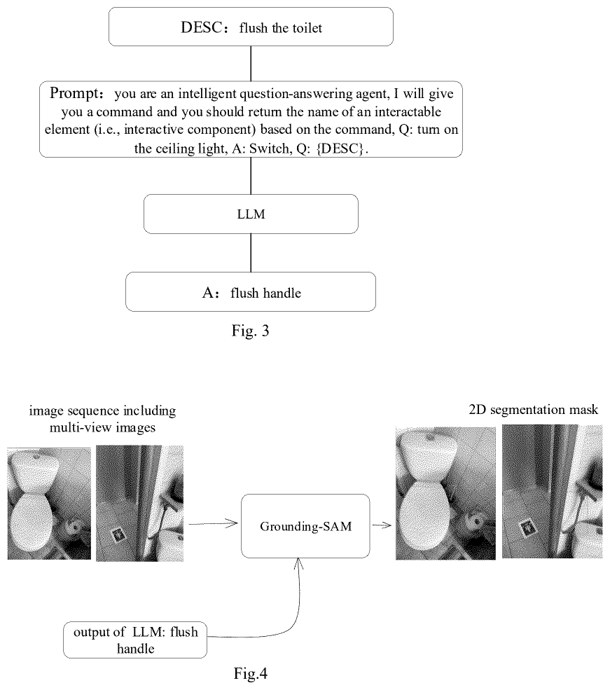

FIG. 3 is a schematic diagram of an input and an output of the LLM. Referring to FIG. 3, assuming that the text description information (Description, DESC for short) of the target task is “flush the toilet”, the prompt of the LLM may be:

Prompt: you are an intelligent question-answering agent, I will give you a command and you should return the name of an interactable element (i.e., interactive component) based on the command, Q: turn on the ceiling light, A: Switch, Q: {DESC}. The {DESC} in the Prompt is the text description information of the target task, and “Q: turn on the ceiling light, A: Switch” is an example.

The LLM generates the name (flush handle) of the interactive component for the target task according to the prompt, and outputs the name of the interactive component.

In order to improve a recall rate of the interactive component of the open-vocabulary 3D target in a real scene, task reasoning is carried out by the LLM in this embodiment, to obtain the name of the interactive component of the target object to be operated by the target task, so as to convert the task into a more direct, open-vocabulary perception task, and then a downstream model can perform matching on an image entity and a text description, thereby prompting the recall rate of the task.

The open-vocabulary 2D detection and segmentation model performs 2D segmentation and detection on an image in the image sequence based on the name of the interactive component output by the LLM so as to obtain the 2D segmentation mask of the interactive component.

The segmentation mask is kind of a computer vision technology, and is configured to accurately separate an object in an image from the background. It implements fine-grained partitioning on an image region by classifying and labeling each pixel. Each pixel point is assigned a label so as to represent that the pixel point belongs to the foreground or the background, or belongs to different object categories; such label information forms a two-dimensional matrix, i.e., the segmentation mask.

The open-vocabulary 2D detection and segmentation model is a multi-modal model, including a text mode and an image mode. By adopting the multi-modal detection and segmentation model, the accuracy of the detection result can be improved.

Exemplarily, the open-vocabulary 2D detection and segmentation model adopts a grounding segment anything model (Grounding-SAM). The Grounding-SAM can automatically detect the object in the image by a text prompt and generate an accurate segmentation mask, has an excellent generalization performance, and can perform effective segmentation on nearly any visible object in various complex scenes.

FIG. 4 is a schematic diagram of a segmentation processing of the Grounding-SAM. As shown in FIG. 4, the image sequence includes multi-view images, and the Grounding-SAM performs segmentation on the multi-view images to obtain all the candidate 2D detection frames and 2D segmentation masks of the interactive component. The Grounding-SAM generally includes a Grounding-DINO model and a segment anything model (SAM). The Grounding-DINO model is configured to perform 2D detection on an interactable object in the image according to the name of the interactable object so as to obtain a 2D detection frame of the interactable object; and the SAM is configured to perform recognition and segmentation on the object in the 2D detection frame to obtain the 2D segmentation mask of the interactable object.

The filtering module is configured to screen a candidate image sequence where the 2D segmentation mask of the interactive component is located according to the text description information of the target task and the candidate image sequence, to obtain a target image sequence. The candidate image sequence may include a plurality of frames of candidate images, and each frame of candidate image includes the 2D segmentation mask of the interactive component.

Optionally, the filtering module adopts a vision-language model (VLM), and filters a preliminary detection result of the open-vocabulary 2D detection and segmentation model. The VLM is a multi-modal model, can simultaneously learn from the image and the text, and constructs a model capable of understanding and generating association between the image and the text by utilizing the deep learning technology and combining the image with the text information. The VLM can be used for scenes of image recognition, visual question-answering, etc.

Exemplarily, the filtering module is, for example, configured to: take the text description information of the target task and the candidate image sequence as inputs of the VLM, where the VLM is configured to extract a text feature of the text description information and an image feature of the 2D segmentation mask of each frame of candidate image in the candidate image sequence and calculate a similarity between the text feature and the image feature of each frame of candidate image; and select, from a plurality of frames of candidate images according to the similarities corresponding to the plurality of frames of candidate images, K frames of candidate images with the highest similarities as the target images, where K frames of target images constitute a target image sequence.

Optionally, for each frame of candidate image, the VLM performs extraction of multi-scale features on the 2D segmentation mask of the candidate image, and aggregates the multi-scale features to obtain the image feature of the candidate image.

Extraction of the multi-scale features is a technology of capturing and analyzing data features on multiple scales (or resolutions), and is widely applied to computer vision. The VLM converts original data of each frame of candidate image into data in such a form that the data can be analyzed on multiple scales, independently extracts the feature on each scale, and aggregates the features extracted from various scales.

In an exemplary implementation, the VLM performs weighted averaging on the multi-scale features to obtain the image feature of the candidate image. Optionally, the VLM may also perform feature splicing on the multi-scale features to obtain the image feature of the candidate image, or the VLM performs feature fusion on the multi-scale features to obtain the image feature of the candidate image.

Optionally, when the similarity between the text feature and the image feature of each frame of candidate image is calculated, a cosine similarity may be adopted. The cosine similarity is a metric for measuring a similarity between two vectors in direction, rather than measuring their similarity in magnitude. In the fields of text analysis, recommendation system, image processing, etc., the cosine similarity is often used to evaluate a similarity between two objects. Certainly, the similarity between the text feature and the image feature of each frame of candidate image may also be calculated by adopting other algorithms, which is not limited in this embodiment.

Optionally, the vision-language model is a contrastive language-image pre-training (CLIP) model which embeds the image and the text into a shared semantic space in a contrastive learning mode. The model can directly calculate the similarity between the image and the text in a vector space. Pre-training of the CLIP is unmonitored, and does not need a large number of annotated data for performing model training.

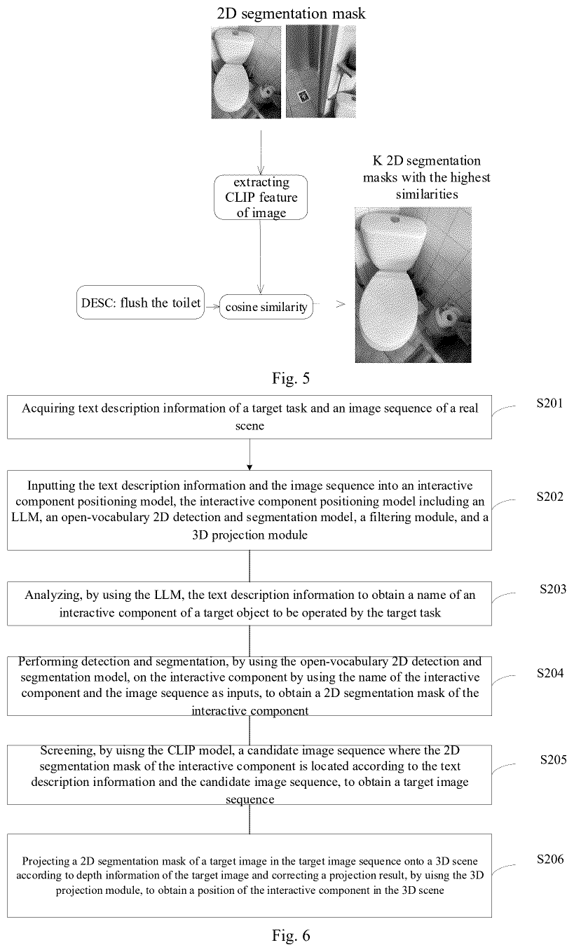

FIG. 5 is a schematic diagram of filtering the image by the CLIP model. Still referring to the example shown in FIG. 3 and FIG. 4, the CLIP model has two inputs: the text description information of the target task and the 2D segmentation mask of each frame of candidate image. The text description information of the target task is “flush the toilet”. The CLIP model performs feature extraction on the text description information of the target task to obtain the text feature, and extracts the feature of the 2D segmentation mask of the candidate image to obtain the image feature of the candidate image. The image feature of the candidate image is also referred to as a CLIP feature of the candidate image. Then the cosine similarity between the text feature and the CLIP feature is calculated; and K frames of candidate images with the highest similarities are selected as the target images.

The vision-language model is a multi-modal model, and includes a text mode and an image mode. By adopting the multi-modal model to perform image filtering, the accuracy of the filtering result can be improved, so that the accuracy of the final positioning result is improved.

The 3D projection module is configured to project a 2D segmentation mask of a target image in the target image sequence onto a 3D scene according to depth information of the target image, and correct the projection result to obtain the position of the interactive component in the 3D scene.

A result obtained after processing of the LLM, the open-vocabulary 2D detection and segmentation model, and the filtering module is a 2D detection result; at this moment, the 2D detection result needs to be converted into a 3D detection result. In this embodiment, the 2D segmentation mask of the interactive component is projected onto the 3D scene by using the 3D projection module. The 3D projection module is configured to project the 2D segmentation mask of the interactive component onto a 3D scene according to the depth information of the image, and correct the projection result to obtain the position of the target object in the 3D scene.

Optionally, in some implementations, the 3D projection module projects the 2D segmentation mask of the interactive component onto the 3D scene (i.e., the real scene) according to the depth information of the target image, and the projection result (i.e., the 3D segmentation mask of the interactive component in the 3D scene) may also be directly used as the position of the interactive component in the 3D scene.

When the 3D projection module performs projecting, the depth information of the image is also required. Correspondingly, when the terminal device acquires the image sequence of the real scene, the depth information of each frame of image also needs to be acquired, and the projection is carried out according to the depth information of the target image where the 2D segmentation mask of the interactive component is located.

The 3D projection module improves the accuracy of the detection result of the 3D target by correcting the projection result.

The final detection result output by the positioning model for an interactive component of an open-vocabulary 3D target includes the position of the interactive component in the 3D scene, and optionally, also may include the name of the interactive component, the name of the target object, etc.

According to the position (which is output by the positioning model for an interactive component of an open-vocabulary 3D target), in the 3D scene, of the interactive component of the target object to be operated by the target task and the operation corresponding to the target task, the terminal device performs the operation on the interactive component. It could be understood that, according to the position of the interactive component in the 3D scene, the terminal device may operate a real interactive component in the 3D scene, or may operate a virtual interactive component in a virtual scene reconstructed by the 3D scene.

In this embodiment, the text description information of the target task and the image sequence of the real scene are acquired and input into the positioning model for an interactive component of an open-vocabulary 3D target so as to obtain the positioning result of the interactive component of the target object to be operated by the target task. The positioning model for an interactive component of an open-vocabulary 3D target includes: the LLM, configured to analyze the text description information to obtain the information of the interactive component of the target object to be operated by the target task; the open-vocabulary 2D detection and segmentation model, configured to perform detection and segmentation on the interactive component by using the information of the interactive component and the image sequence as the input so as to obtain the 2D segmentation mask of the interactive component; the filtering module, configured to screen a candidate image sequence where the 2D segmentation mask of the interactive component is located according to the text description information and the candidate image sequence, to obtain the target image sequence; and the 3D projection module, configured to project the 2D segmentation mask of the target image in the target image sequence onto the 3D scene according to the depth information of the target image, and correct the projection result to obtain the position of the interactive component in the 3D scene. According to the method, the detection on the interactive component of the open-vocabulary 3D target is carried out by using a plurality of pre-trained multi-modal models, so that the accuracy of the detection result is improved.

An Embodiment II of the present disclosure provides a method of detecting an open-vocabulary 3D target. FIG. 6 is a flowchart of a method for positioning an interactive component of an open-vocabulary 3D target, as provided by the Embodiment II of the present disclosure. Referring to FIG. 2 and FIG. 6, the method provided by this embodiment includes the following steps.
S201: acquiring text description information of a target task and an image sequence of a real scene.
S202: inputting the text description information and the image sequence into an interactive component positioning model, the interactive component positioning model including an LLM, an open-vocabulary 2D detection and segmentation model, a filtering module, and a 3D projection module.
S203: analyzing, by using the LLM, the text description information to obtain a name of an interactive component of a target object to be operated by the target task.
S204: performing detection and segmentation, by using the open-vocabulary 2D detection and segmentation model, on the interactive component by using the name of the interactive component and the image sequence as inputs, to obtain a 2D segmentation mask of the interactive component.
S205: screening, by using the CLIP model, a candidate image sequence where the 2D segmentation mask of the interactive component is located according to the text description information and the candidate image sequence, to obtain a target image sequence.

The specific implementations of the steps S201-S205 refer to the related description in the Embodiment I, and will not be repeated herein.
S206: projecting a 2D segmentation mask of a target image in the target image sequence onto a 3D scene according to depth information of the target image and correcting a projection result, by using the 3D projection module, to obtain a position of the interactive component in the 3D scene.

When the target image sequence includes a plurality of frames of target images, the 3D projection module merges and projects 2D segmentation masks of the plurality of frames of target images onto the 3D scene according to depth information of the plurality of frames of target images so as to obtain a first 3D segmentation mask of the interactive component.

When acquiring an image sequence of a real scene, the terminal device may also acquire depth information of each frame of image. The terminal device may acquire the depth information of each frame of image by using a depth camera. For each frame of target image, according to depth information and a 2D segmentation mask of the target image, the 3D projection module obtains a three-dimensional coordinate of each pixel point of the 2D segmentation mask in a 3D scene (i.e., the real scene), and 3D points obtained by projecting the pixel points of all the 2D segmentation masks of the interactive component onto the 3D scene constitute the first 3D segmentation mask.

Point cloud formed by all the points of the first 3D segmentation mask generally is sparse, and is referred to as sparse point cloud of the first 3D segmentation mask. The 3D projection module, firstly, performs point cloud augmentation on the sparse point cloud of the first 3D segmentation mask to obtain a complete and dense second 3D segmentation mask, and then corrects the second 3D segmentation mask by adopting the following correction strategies:
(1) re-projecting the second 3D segmentation mask onto a plurality of frames of target images to obtain a first 2D segmentation mask of the interactive component in each frame of target image; and for each frame of target image, according to a position of the 2D segmentation mask of the target image, filtering out projected points outside the 2D segmentation mask of the target image, from the first 2D segmentation mask, to obtain a second 2D segmentation mask of the interactive component.
(2) projecting second 2D segmentation masks of a plurality of frames of target images onto the 3D scene according to the depth information of the plurality of frames of target images, to obtain a third 3D segmentation mask; and determining the position of the interactive component in the 3D scene according to the third 3D segmentation mask.

Exemplarily, the 3D projection module may perform nearest neighboring point cloud augmentation on the sparse point cloud of the first 3D segmentation mask by adopting k-nearest neighbor (KNN) algorithm, and obtain the complete and dense second 3D segmentation mask by the nearest neighboring point cloud augmentation.

When the point cloud augmentation is carried out on the sparse point cloud of the first 3D segmentation mask, some non-target points will be introduced. In order to filter out the non-target points introduced when the point cloud augmentation is carried out on the sparse point cloud, the 3D projection module re-projects the second 3D segmentation mask back to a 2D space.

Re-projection refers to projecting 3D points in the 3D scene onto a two-dimensional image (i.e., the 2D space). When the second 3D segmentation mask is re-projected onto the 2D space, the second 3D segmentation mask needs to be re-projected onto each frame of target image. The 3D projection module needs to acquire a camera pose and a camera internal parameter of each frame of target image, and re-projects each 3D point in the second 3D segmentation mask onto the target image according to the camera pose and the camera internal parameter of each frame of target image, so as to obtain the first 2D segmentation mask of the target object in each frame of target image. The first 2D segmentation mask is a 2D segmentation mask obtained by re-projection.

A pixel point in the 2D segmentation mask obtained by re-projection is also referred to as a projected point. Part of the projected points in the first 2D segmentation mask of each frame of target image is possibly positioned outside a 2D segmentation mask region of the target image. For each frame of target image, according to the position of the 2D segmentation mask of the target image, the projected points outside the 2D segmentation mask of the target image are filtered out from all the projected points of the first 2D segmentation mask, and only the projected points of the first 2D segmentation mask that are located in the 2D segmentation mask of the target image are retained, so as to obtain the second 2D segmentation mask of the interactive component.

Finally, the second 2D segmentation masks of the plurality of frames of target images are merged and projected onto the 3D scene according to the depth information of the plurality of frames of target images so as to obtain the third 3D segmentation mask, and then the position of the interactive component in the 3D scene is determined according to the third 3D segmentation mask.

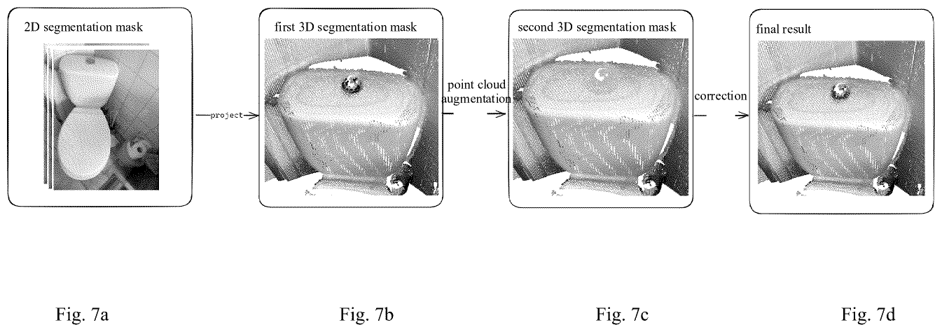

FIGS. 7a-7d are schematic diagrams of data changes in the projecting and correcting process of the 3D projection module. As shown in FIGS. 7a-7d, the 3D projection module, firstly, merges and projects 2D segmentation masks (i.e., as shown in FIG. 7a) of a plurality of frames of target images onto a first 3D segmentation mask as shown in FIG. 7b, then performs point cloud augmentation on sparse point cloud of the first 3D segmentation mask to obtain a complete and dense second 3D segmentation mask as shown in FIG. 7c, and finally, corrects the second 3D segmentation mask to obtain a final 3D segmentation mask as shown in FIG. 7d.

In an optional implementation, pixel points in the third 3D segmentation mask are directly used as pixel points of the interactive component, so as to obtain a 3D position of the interactive component in the 3D scene.

In another optional implementation, noise points in the third 3D segmentation mask are filtered out to obtain a fourth 3D segmentation mask, and the position of the interactive component in the 3D scene is determined according to the fourth 3D segmentation mask.

Generally, the third 3D segmentation mask may include noise points, and by filtering out the noise points from the third 3D segmentation mask, the accuracy of the detection result of the interactive component of the open-vocabulary 3D target is improved.

Optionally, a connected component is determined according to the points in the third 3D segmentation mask, and isolated noise points of the third 3D segmentation mask are filtered out according to a size of the connected component to obtain a fourth 3D segmentation mask. The isolated noise points refer to points outside the connected component, and these points generally are not connected with other points and thus are referred to as the isolated noise points.

Optionally, the target image sequence may also only include one frame of target image. Correspondingly, the 3D projection module is, for example, configured to: project a 2D segmentation mask of this frame of target image onto the 3D scene according to depth information of this frame of target image, to obtain the first 3D segmentation mask of the interactive component. What is different from the case of the 2D segmentation masks of a plurality of frames of target images is that, when there is only the 2D segmentation mask of one frame of target image, it has no need of merging for projecting but only needs to project the 2D segmentation mask of the single frame of target image onto the 3D scene. The correction method after projection is the same with the case of a plurality of frames of target images, and will not be repeated herein.

In this embodiment, the positioning model for an interactive component of an open-vocabulary 3D target is adopted to detect and position the interactive component of the open-vocabulary 3D target. The positioning model for an interactive component of an open-vocabulary 3D target includes the LLM, the open-vocabulary 2D detection and segmentation model, the filtering module, and the 3D projection module. The filtering module may adopt a multi-modal model. Positioning on the interactive component of the open-vocabulary 3D target is implemented by pipeline processing of the plurality of pre-training models, so that the accuracy of positioning the interactive component of the open-vocabulary 3D target in the real scene and the recall rate are improved.

The method for positioning an interactive component of an open-vocabulary 3D target, as provided by the embodiments of the present disclosure, may be applied in the field of MR. When a user uses a MR application on an XR device to play games or perform other tasks, the user may wear a headset device and move in a room (i.e., a real scene), a camera of the headset device acquires a room image, the room is displayed on a displayer by utilizing a video pass-through (VST) function, and positioning can be carried out on the interactive component of the open-vocabulary 3D target by utilizing the room image, so as to perceive and understand objects in the room and perform a corresponding operation on the positioned interactive component of the 3D target according to an input target task.

The positioning model for an interactive component of an open-vocabulary 3D target may detect an interactive component of a 3D object which is new or never appears before. When a new object appears in the room, the positioning model for an interactive component of an open-vocabulary 3D target also can position an interactive component of the object, and perform a corresponding operation on the interactive component. In addition, the positioning model for an interactive component of an open-vocabulary 3D target has better adaptability, can be applied in different 3D scenes, and achieves good performance.

The method for positioning an interactive component of an open-vocabulary 3D target, as provided by the embodiments of the present disclosure, may also be applied to robots. A user inputs a target task on the robot; and the positioning model for an interactive component of an open-vocabulary 3D target obtains a position of an interactive component of a target object to be operated by the target task in a 3D scene by positioning according to the target task and the 3D scene, and performs an operation corresponding to the target task on the interactive component according to the operation. For example, when the target task is “flush the toilet”, an output of the positioning model for an interactive component of an open-vocabulary 3D target is a position of a flush handle, and the robot operates the flush handle according to the position of the flush handle so as to achieve a flushing function; or when the target task is “turn on the light”, an output of the positioning model for an interactive component of an open-vocabulary 3D target is a position of a switch of a ceiling light, and the robot operates the switch of the ceiling light according to the position of the switch of the ceiling light so as to achieve a function of turning on the light.

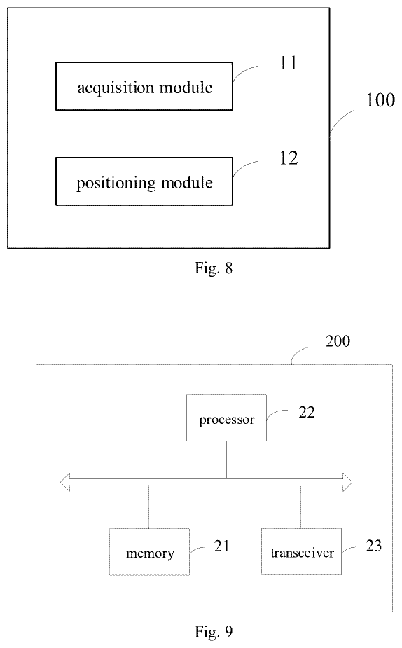

In order to implement the method for positioning an interactive component of an open-vocabulary 3D target as provided by the embodiments of the present disclosure in a better way, an embodiment of the present disclosure further provides an apparatus for positioning an interactive component of an open-vocabulary 3D target. FIG. 8 is a schematic structural diagram of an apparatus for positioning an interactive component of an open-vocabulary 3D target, as provided by an Embodiment III of the present disclosure. As shown in FIG. 8, the apparatus 100 for positioning an interactive component of an open-vocabulary 3D target may include:
an acquisition module 11, configured to acquire text description information of a target task and an image sequence of a real scene; and
a positioning module 12, configured to input the text description information and the image sequence into a positioning model for an interactive component of an open-vocabulary 3D target so as to obtain a positioning result of an interactive component of a target object to be operated by the target task, where the positioning model for an interactive component of an open-vocabulary 3D target includes an LLM, an open-vocabulary 2D detection and segmentation model, a filtering module, and a 3D projection module;
the LLM is configured to analyze the text description information to obtain information of the interactive component of the target object to be operated by the target task;
the open-vocabulary 2D detection and segmentation model is configured to perform detection and segmentation on the interactive component by using the information of the interactive component and the image sequence as inputs so as to obtain a 2D segmentation mask of the interactive component;
the filtering module is configured to screen a candidate image sequence where the 2D segmentation mask of the interactive component is located according to the text description information and the candidate image sequence, to obtain a target image sequence; and
the 3D projection module is configured to project a 2D segmentation mask of a target image in the target image sequence onto a 3D scene according to depth information of the target image, and correct a projection result to obtain a position of the interactive component in the 3D scene.

In some exemplary implementations, the filtering module is, for example, configured to:
take the text description information and the candidate image sequence as an input of a vision-language model, where the vision-language model is configured to extract a text feature of the text description information and an image feature of a 2D segmentation mask of each frame of candidate image in the candidate image sequence, and calculate a similarity between the text feature and the image feature of each frame of candidate image; and
select K frames of candidate images with the highest similarities, from a plurality of frames of candidate images according to the similarities corresponding to the plurality of frames of candidate images, as the target images.

In some exemplary implementations, the vision-language model is, for example, configured to:
perform, for each frame of candidate image, extraction of multi-scale features on the 2D segmentation mask of the candidate image, and aggregate the multi-scale features to obtain the image feature of the candidate image.

In some exemplary implementations, the vision-language model aggregates the multi-scale features to obtain the image feature of the candidate image, including:
performing weighted averaging on the multi-scale features to obtain the image feature of the candidate image.

In some exemplary implementations, the vision-language model is a CLIP model.

In some exemplary implementations, the target image sequence includes a plurality of frames of target images, and the 3D projection module is, for example, configured to:
merge and project 2D segmentation masks of a plurality of frames of target images onto the 3D scene according to depth information of the plurality of frames of target images, so as to obtain a first 3D segmentation mask of the interactive component;
perform point cloud augmentation on sparse point cloud of the first 3D segmentation mask to obtain a complete and dense second 3D segmentation mask;
re-project the second 3D segmentation mask onto the plurality of frames of target images to obtain a first 2D segmentation mask of the interactive component in each frame of target image;
filter out, for each frame of target image, projected points outside the 2D segmentation mask of the target image from the first 2D segmentation mask according to a position of the 2D segmentation mask of the target image, to obtain a second 2D segmentation mask of the interactive component;
project the second 2D segmentation masks of the plurality of frames of target images onto the 3D scene according to depth information of the plurality of frames of target images, to obtain a third 3D segmentation mask; and
determine the position of the interactive component in the 3D scene according to the third 3D segmentation mask.

In some exemplary implementations, the 3D projection module determines the position of the interactive component in the 3D scene according to the third 3D segmentation mask, including:
filtering out noise points from the third 3D segmentation mask to obtain a fourth 3D segmentation mask; and
determining the position of the interactive component in the 3D scene according to the fourth 3D segmentation mask.

In some exemplary implementations, the filtering out noise points from the third 3D segmentation mask to obtain a fourth 3D segmentation mask includes:
determining a connected component according to a pixel point in the third 3D segmentation mask, and filtering out isolated noise points from the third 3D segmentation mask according to a size of the connected component so as to obtain the fourth 3D segmentation mask.

In some exemplary implementations, the LLM is configured to analyze the text description information to obtain the information of the interactive component of the target object to be operated by the target task, including:
generating a prompt of the LLM according to the text description information; and
inputting the prompt into the LLM to obtain a name of the interactive component of the target object to be operated by the target task.

In some exemplary implementations, the open-vocabulary 2D detection and segmentation model adopts a grounding-SAM.

It should be understood that the apparatus embodiments and the method embodiments may correspond to each other, and similar descriptions may refer to the method embodiments. In order to avoid repetition, similar descriptions will not be repeated herein.

The apparatus 100 provided by the embodiment of the present disclosure is described above from the aspect of functional modules in connection with the drawings. It should be understood that the functional modules can be implemented in the form of hardware, or by means of software instructions, and it can also be realized through the combination of hardware and software modules. Specifically, the steps of the method embodiments in the embodiments of the present disclosure may be completed by an integrated logic circuit in a hardware form in a processor and/or software instructions, and the steps of the method disclosed by the embodiments of the present disclosure may be directly executed and completed by a hardware decoding processor, or executed and completed by combining hardware and software modules in the decoding processor. Optionally, the software module may be positioned in a matured storage medium in the field, such as a random memory, a flash memory, a read-only memory, a programmable read-only memory, an electrically erasable programmable memory, a register, etc. The storage medium is positioned in the memory, and the processor reads information in the memory and completes the steps in the method embodiments above in combination with hardware thereof.

An embodiment of the present disclosure further provides an electronic device. FIG. 9 is a schematic structural diagram of an electronic device provided by an Embodiment IV of the present disclosure. As shown in FIG. 9, the electronic device 200 may include:
a memory 21 and a processor 22, where the memory 21 is configured to store a computer program and transmit codes of the program to the processor 22. In other words, the processor 22 may invoke and execute the computer program from the memory 21 so as to implement the method as described in the embodiments of the present disclosure.

For example, the processor 22 may be configured to execute the method as described in the method embodiments according to instructions in the computer program.

In some embodiments of the present disclosure, the processor 22 may include, but is not limited to:
a general-purpose processor, a digital signal processor (DSP), an application specific integrated circuit (ASIC), a field programmable gate array (FPGA) or other programmable logic devices, a discrete gate or a transistor logic device, a discrete hardware component, etc.

In some embodiments of the present disclosure, the memory 21 includes, but is not limited to:
a volatile memory and/or a non-volatile memory, where the non-volatile memory may be a read-only memory (ROM), a programmable ROM (PROM), an erasable PROM (EPROM), an electrically EPROM (EEPROM), or a flash memory. The volatile memory may be a random-access memory (RAM) which is used as an external high-speed cache. By way of example without limiting, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct Rambus RAM (DR RAM).

In some embodiments of the present disclosure, the computer program can be segmented into one or more modules, and the one or more modules are stored in the memory 21 and executed by the processor 22 so as to complete the method provided by the present disclosure. The one or more modules may be a series of computer program instruction segments capable of completing specific functions, and the instruction segments are configured to describe the executing process of the computer program in the electronic device.

As shown in FIG. 9, the electronic device may further include: a transceiver 23, a display screen (which is not shown in the drawing), etc. The transceiver 23 may be connected to the processor 22 or the memory 21, and the display screen may be connected to the processor 22 or the memory 21.

The processor 22 may control the transceiver 23 to communicate with other devices, and specifically, the transceiver may transmit information or data to other devices, or receive information or data transmitted by other devices. The transceiver 23 may include a transmitter and a receiver. The transceiver 23 also may further include an antenna. There may be one or more antennas.

The display screen may be configured to display a graphical user interface and receive an operation instruction generated when a user acts on the graphical user interface. The display screen may be a touch display screen, and the touch display screen may include a display panel and a touch panel, where the display panel may be configured to display information input by the user or information provided to the user and various graphical user interfaces of the computer device, and these graphical user interfaces may be formed by graphs, texts, icons, videos, and a random combination thereof. Optionally, the display panel may be configured in a form of a liquid crystal display (LCD), an organic light-emitting diode (OLED), etc. The touch panel may be configured to collect a touch operation (for example, an operation of the user by using any proper object or attachment such as a finger, a touch pen, and the like on the touch panel or near the touch panel) of the user on or near the touch panel and generate a corresponding operation instruction, and the operation instruction executes a corresponding program. Optionally, the touch panel may include two parts: a touch detection apparatus and a touch controller, wherein the touch detection apparatus detects an orientation of the user, detects a signal brought by the touch operation, and transmits the signal to the touch controller; the touch controller receives touch information from the touch detection apparatus, converts the touch information into touch spot coordinates, and then transmits the touch spot coordinates to the processor 32, and can receive and execute a command transmitted by the processor 32. The touch panel may cover the display panel; when detecting the touch operation on or near the touch panel, the touch panel transmits the touch operation to the processor 32 to determine the type of a touch event; and then the processor 32 provides a corresponding visual output on the display panel according to the type of the touch event.

It could be understood that although it is not shown in FIG. 9, the electronic device 200 may further include a camera module, a wireless fidelity (WIFI) module, a positioning module, a Bluetooth module, an audio module, etc., which are not repeated herein.

It should be understood that the components in the electronic device are connected by a bus system, where the bus system, in addition to a data bus, further includes a power bus, a control bus, and a state signal bus.

The present disclosure further provides a computer storage medium having a computer program stored thereon. When the computer program is executed by a computer, the computer can execute the methods of the method embodiments. Or, an embodiment of the present disclosure further provides a computer program product including an instruction. When the instruction is executed by the computer, the computer executes the methods of the method embodiments.

The present disclosure further provides a computer program product. The computer program product includes a computer program, and the computer program is stored in a computer-readable storage medium. A processor of a server reads the computer program from the computer-readable storage medium, and executes the computer program, so that the server executes corresponding flow in a method of controlling a user position in a virtual scene in the embodiments of the present disclosure, which will not be repeated herein for brevity.

In several embodiments provided by the present disclosure, it should be understood that the disclosed system, apparatus, and method may be implemented in other modes. For example, the above-described apparatus embodiments are merely schematic. For example, partitioning of the modules is merely logic functional partitioning. In the actual implementation, there may be additional partitioning modes, and for example, a plurality of modules or components may be combined or may be integrated to another system, or some features may be neglected or not executed. In addition, displayed or discussed mutual coupling or direct coupling or communicative connection may be implemented through some interfaces, and indirect coupling or communicative connection between devices or modules may be electrical, mechanical or in other forms.

The modules illustrated as separated components may be, or may not be, physically separated, and components displayed as modules may be, or may not be, physical modules, i.e., the modules may be positioned at a position, or may be distributed over a plurality of network elements. Part or all of the modules may be selected according to actual demands to realize the purpose of the technical solution(s) of the embodiments. For example, various functional modules in various embodiments of the present disclosure may be integrated in one processing module or may exist separately and physically, or two or more modules may be integrated in one module.

The foregoing merely refers to specific implementations of the present disclosure, but the scope of protection of the present disclosure is not limited thereto; those skilled in the art may easily conceive of variations or replacements in the technical scope disclosed by the present disclosure, and those variations and replacements shall fall within the scope of protection of the present disclosure. Therefore, the scope of protection of the present disclosure should be subject to that of the claims.

1. A method for positioning an interactive component of an open-vocabulary 3D target, comprising:
acquiring text description information of a target task and an image sequence of a real scene; and
inputting the text description information and the image sequence into an interactive component positioning model to obtain a positioning result of an interactive component of a target object to be operated by the target task, wherein the interactive component positioning model comprises a large language model (LLM), an open-vocabulary 2D detection and segmentation model, a filtering module, and a 3D projection module;
the LLM is configured to analyze the text description information to obtain information of the interactive component of the target object to be operated by the target task;
the open-vocabulary 2D detection and segmentation model is configured to perform detection and segmentation on the interactive component by using the information of the interactive component and the image sequence as an input, to obtain a 2D segmentation mask of the interactive component;
the filtering module is configured to screen a candidate image sequence where the 2D segmentation mask of the interactive component is located according to the text description information and the candidate image sequence, to obtain a target image sequence; and
the 3D projection module is configured to project a 2D segmentation mask of a target image in the target image sequence onto a 3D scene according to depth information of the target image, and correct a projection result to obtain a position of the interactive component in the 3D scene.

2. The method according to claim 1, wherein the filtering module is configured to:
take the text description information and the candidate image sequence as an input of a vision-language model, wherein the vision-language model is configured to extract a text feature of the text description information and an image feature of a 2D segmentation mask of each frame of candidate image in the candidate image sequence, and calculate a similarity between the text feature and the image feature of each frame of candidate image; and
select, from a plurality of frames of candidate images according to similarities corresponding to the plurality of frames of candidate images, K frames of candidate images with highest similarities as the target image.

3. The method according to claim 2, wherein the vision-language model is configured to:
extract, for each frame of candidate image, multi-scale features from the 2D segmentation mask of the candidate image, and aggregate the multi-scale features to obtain the image feature of the candidate image.

4. The method according to claim 3, wherein the vision-language model aggregates the multi-scale features to obtain the image feature of the candidate image, which is realized by:
performing weighted averaging on the multi-scale features to obtain the image feature of the candidate image.

5. The method according to claim 2, wherein the vision-language model is a contrastive language-image pre-training (CLIP) model.

6. The method according to claim 1, wherein the target image sequence comprises a plurality of frames of target images, and the 3D projection module is configured to:
merge and project 2D segmentation masks of the plurality of frames of target images onto the 3D scene according to depth information of the plurality of frames of target images, to obtain a first 3D segmentation mask of the interactive component;
perform point cloud augmentation on sparse point cloud of the first 3D segmentation mask, to obtain a complete and dense second 3D segmentation mask;
re-project the second 3D segmentation mask onto the plurality of frames of target images to obtain a first 2D segmentation mask of the interactive component in each frame of target image;
filter out, for each frame of target image, a projected point outside the 2D segmentation mask of the target image, from the first 2D segmentation mask according to a position of the 2D segmentation mask of the target image, to obtain a second 2D segmentation mask of the interactive component;
project second 2D segmentation masks of the plurality of frames of target images onto the 3D scene according to depth information of the plurality of frames of target images, to obtain a third 3D segmentation mask; and
determine the position of the interactive component in the 3D scene according to the third 3D segmentation mask.

7. The method according to claim 6, wherein the 3D projection module is configured to determine the position of the interactive component in the 3D scene according to the third 3D segmentation mask, which is realized by:
filtering out a noise point from the third 3D segmentation mask to obtain a fourth 3D segmentation mask; and
determining the position of the interactive component in the 3D scene according to the fourth 3D segmentation mask.

8. The method according to claim 7, wherein the filtering out a noise point from the third 3D segmentation mask to obtain a fourth 3D segmentation mask comprises:
determining a connected component according to a pixel point in the third 3D segmentation mask, and filtering out an isolated noise point from the third 3D segmentation mask according to a size of the connected component, to obtain the fourth 3D segmentation mask.

9. The method according to claim 1, wherein the LLM is configured to analyze the text description information to obtain the information of the interactive component of the target object to be operated by the target task, which is realized by:
generating a prompt of the LLM according to the text description information; and
inputting the prompt into the LLM to obtain a name of the interactive component of the target object to be operated by the target task.

10. The method according to claim 1, wherein a grounding segment anything model (grounding-SAM) is adopted as the open-vocabulary 2D detection and segmentation model.

11. An electronic device, comprising a processor and a memory, wherein the memory is configured to store a computer program, and the processor is configured to invoke and execute the computer program stored in the memory, so as to execute a method for positioning an interactive component of an open-vocabulary 3D target, comprising:
acquiring text description information of a target task and an image sequence of a real scene; and
inputting the text description information and the image sequence into an interactive component positioning model to obtain a positioning result of an interactive component of a target object to be operated by the target task, wherein the interactive component positioning model comprises a large language model (LLM), an open-vocabulary 2D detection and segmentation model, a filtering module, and a 3D projection module;
the LLM is configured to analyze the text description information to obtain information of the interactive component of the target object to be operated by the target task;
the open-vocabulary 2D detection and segmentation model is configured to perform detection and segmentation on the interactive component by using the information of the interactive component and the image sequence as an input, to obtain a 2D segmentation mask of the interactive component;
the filtering module is configured to screen a candidate image sequence where the 2D segmentation mask of the interactive component is located according to the text description information and the candidate image sequence, to obtain a target image sequence; and
the 3D projection module is configured to project a 2D segmentation mask of a target image in the target image sequence onto a 3D scene according to depth information of the target image, and correct a projection result to obtain a position of the interactive component in the 3D scene.

12. The electronic device according to claim 11, wherein in the method for positioning an interactive component of an open-vocabulary 3D target,
the filtering module is configured to:
take the text description information and the candidate image sequence as an input of a vision-language model, wherein the vision-language model is configured to extract a text feature of the text description information and an image feature of a 2D segmentation mask of each frame of candidate image in the candidate image sequence, and calculate a similarity between the text feature and the image feature of each frame of candidate image; and
select, from a plurality of frames of candidate images according to similarities corresponding to the plurality of frames of candidate images, K frames of candidate images with highest similarities as the target image.

13. The electronic device according to claim 12, wherein in the method for positioning an interactive component of an open-vocabulary 3D target,
the vision-language model is configured to:
extract, for each frame of candidate image, multi-scale features from the 2D segmentation mask of the candidate image, and aggregate the multi-scale features to obtain the image feature of the candidate image.

14. The electronic device according to claim 13, wherein in the method for positioning an interactive component of an open-vocabulary 3D target,
the vision-language model aggregates the multi-scale features to obtain the image feature of the candidate image, which is realized by:
performing weighted averaging on the multi-scale features to obtain the image feature of the candidate image.

15. The electronic device according to claim 12, wherein in the method for positioning an interactive component of an open-vocabulary 3D target, the vision-language model is a contrastive language-image pre-training (CLIP) model.

16. The electronic device according to claim 11, wherein in the method for positioning an interactive component of an open-vocabulary 3D target,
the target image sequence comprises a plurality of frames of target images, and the 3D projection module is configured to:
merge and project 2D segmentation masks of the plurality of frames of target images onto the 3D scene according to depth information of the plurality of frames of target images, to obtain a first 3D segmentation mask of the interactive component;
perform point cloud augmentation on sparse point cloud of the first 3D segmentation mask, to obtain a complete and dense second 3D segmentation mask;
re-project the second 3D segmentation mask onto the plurality of frames of target images to obtain a first 2D segmentation mask of the interactive component in each frame of target image;
filter out, for each frame of target image, a projected point outside the 2D segmentation mask of the target image, from the first 2D segmentation mask according to a position of the 2D segmentation mask of the target image, to obtain a second 2D segmentation mask of the interactive component;
project second 2D segmentation masks of the plurality of frames of target images onto the 3D scene according to depth information of the plurality of frames of target images, to obtain a third 3D segmentation mask; and
determine the position of the interactive component in the 3D scene according to the third 3D segmentation mask.

17. The electronic device according to claim 16, wherein in the method for positioning an interactive component of an open-vocabulary 3D target,
the 3D projection module is configured to determine the position of the interactive component in the 3D scene according to the third 3D segmentation mask, which is realized by:
filtering out a noise point from the third 3D segmentation mask to obtain a fourth 3D segmentation mask; and
determining the position of the interactive component in the 3D scene according to the fourth 3D segmentation mask.

18. The electronic device according to claim 17, wherein in the method for positioning an interactive component of an open-vocabulary 3D target,
the filtering out a noise point from the third 3D segmentation mask to obtain a fourth 3D segmentation mask comprises:
determining a connected component according to a pixel point in the third 3D segmentation mask, and filtering out an isolated noise point from the third 3D segmentation mask according to a size of the connected component, to obtain the fourth 3D segmentation mask.

19. The electronic device according to claim 11, wherein in the method for positioning an interactive component of an open-vocabulary 3D target,
the LLM is configured to analyze the text description information to obtain the information of the interactive component of the target object to be operated by the target task, which is realized by:
generating a prompt of the LLM according to the text description information; and
inputting the prompt into the LLM to obtain a name of the interactive component of the target object to be operated by the target task.

20. A non-transitory computer-readable storage medium on which a computer program is stored, wherein the computer program enables a computer to execute a method for positioning an interactive component of an open-vocabulary 3D target, comprising:
acquiring text description information of a target task and an image sequence of a real scene; and
inputting the text description information and the image sequence into an interactive component positioning model to obtain a positioning result of an interactive component of a target object to be operated by the target task, wherein the interactive component positioning model comprises a large language model (LLM), an open-vocabulary 2D detection and segmentation model, a filtering module, and a 3D projection module;
the LLM is configured to analyze the text description information to obtain information of the interactive component of the target object to be operated by the target task;
the open-vocabulary 2D detection and segmentation model is configured to perform detection and segmentation on the interactive component by using the information of the interactive component and the image sequence as an input, to obtain a 2D segmentation mask of the interactive component;
the filtering module is configured to screen a candidate image sequence where the 2D segmentation mask of the interactive component is located according to the text description information and the candidate image sequence, to obtain a target image sequence; and
the 3D projection module is configured to project a 2D segmentation mask of a target image in the target image sequence onto a 3D scene according to depth information of the target image, and correct a projection result to obtain a position of the interactive component in the 3D scene.
